(19) United States
(12) Patent Application Publication
(10) Pub. No.: US 2011/0029214 A1
(43) Pub. Date: Feb. 3, 2011

(54) DEVICE AND METHOD FOR MONITORING VEHICLE TIRES

(76) Inventor: Jianzhong FU, Guilin (CN)

Correspondence Address: MATTHIAS SCHOLL, 14781 MEMORIAL DRIVE, SUITE 1319, HOUSTON, TX, 77079, US

(21) Appl. No.: 12/901,589

(22) Filed: Oct. 11, 2010

Related U.S. Application Data
(63) Continuation of application No. PCT/CN2009/071206, filed on Apr. 9, 2009.

(30) Foreign Application Priority Data
Apr. 10, 2008 (CN) 200810091027.0

(51) Int. Cl. B60T 8/1761; G06F 15/00

(52) U.S. Cl. 701/75; 702/148

(57) ABSTRACT

A method for monitoring vehicle tires by: 1) determining that a complete deflation or blow-out occurs if speed variation of one wheel of a vehicle is larger than or equal to a threshold value, and wheel speeds of other wheels of the vehicle are approximately constant, 2) associating a blow-out or complete deflation speed increment ratio ΔV₂ with a ratio of an normal impeller diameter Rₙₒᵣₘₐₗ to a complete deflation impeller diameter R_{deflation}, and 3) detecting whether a real-time speed increment ratio ΔV of one wheel is greater than or equal to the blow-out or complete deflation speed increment ratio threshold ΔV1, wheel speeds of other wheels are approximately constant, and a real-time speed increment variation rate is greater than or equal to the blow-out or complete deflation speed increment variation rate threshold ΔV1/Δt.

### CROSS-REFERENCE TO RELATED APPLICATIONS

This application is a continuation of International Patent Application No. PCT/CN2009/071206 with an international filing date of Apr. 9, 2009, designating the United States, now pending, and further claims priority benefits to Chinese Patent Application No. 200810091027.0 filed on Apr. 10, 2008. The contents of all of the aforementioned applications, including any intervening amendments thereto, are incorporated herein by reference.

### BACKGROUND OF THE INVENTION

1. Field of the Invention

The invention relates to a method and a device for monitoring tire blow-outs.

2. Description of the Related Art

Tire pressure monitoring systems (TPMS) are widely used in automobiles nowadays. Conventional TPMS systems comprise direct tire pressure monitoring systems, and indirect tire pressure monitoring systems.

In a direct tire pressure monitoring system, a barometric pressure sensor disposed in a tire monitors variation of tire pressure, data signals are transmitted via radio frequency, and a monitor displays pressure and temperature of all tires, and provides a driver with warning information. However, the direct tire pressure monitoring system is incapable of monitoring and sampling sudden danger such as blow-out and so on in real-time.

For an indirect tire pressure monitoring system, monitoring of tire pressure is implemented by monitoring signals from an anti-lock brake system (ABS) wheel speed sensor, and via a wheel speed comparing method, and an effective rolling radius method. However, since variation of a wheel diameter caused by variation of tire pressure is very small, problems such as a low signal amplitude, poor real-time capability, too many environment impacts, sophisticated algorithms, response lag, and limitation of a monitored speed (no greater than 100 km/h) still exist, which makes the system unsuitable for monitoring and sampling instant blow-out during high-speed traveling.

### SUMMARY OF THE INVENTION

In view of the above-described problem, it is one objective of the invention to provide a blow-out monitoring method that is capable of addressing the above-mentioned problems.

It is another objective of the invention to provide a blow-out monitoring device that is capable of addressing the above-mentioned problems.

To achieve the above objectives, in accordance with one embodiment of the invention, provided is a blow-out monitoring method, comprising determining that complete deflation or blow-out occurs if speed variation of one wheel of a vehicle is larger than or equal to a threshold value, and wheel speeds of other wheels of the vehicle are approximately constant, the threshold value comprising a blow-out or complete deflation speed increment ratio threshold ΔV1, and a blow-out or complete deflation speed increment variation rate threshold ΔV1/Δt, associating a blow-out or complete deflation speed increment ratio ΔV₂ with a ratio of an normal impeller diameter Rₙₒᵣₘₐₗ to a complete deflation impeller diameter R_{deflation}, detecting whether a real-time speed increment ratio ΔV of one wheel is greater than or equal to the blow-out or complete deflation speed increment ratio threshold ΔV1, wheel speeds of other wheels are approximately constant, and a real-time speed increment variation rate is greater than or equal to the blow-out or complete deflation speed increment variation rate threshold ΔV1/Δt, determining that deflation occurs if the real-time speed increment ratio ΔV of one wheel is greater than or equal to the blow-out or complete deflation speed increment ratio threshold ΔV1, and the wheel speeds of other wheels are approximately constant, and determining that blow-out occurs if the real-time speed increment ratio ΔV of one wheel is greater than or equal to the blow-out or complete deflation speed increment ratio threshold ΔV1, the wheel speeds of other wheels are approximately constant, and the real-time speed increment variation rate is greater than or equal to the blow-out or complete deflation speed increment variation rate threshold ΔV1/Δt.

In a class of this embodiment, the blow-out or complete deflation speed increment ratio ΔV₂ is equal to (the normal impeller diameter Rₙₒᵣₘₐₗ/the complete deflation impeller diameter R_{deflation}−1)×100%.

In a class of this embodiment, the blow-out or complete deflation speed increment ratio ΔV₂ is dependent on dimension of a wheel and a rim, and is independent on quality of the wheel, an environment, and a drive speed.

In a class of this embodiment, the blow-out or complete deflation speed increment ratio threshold ΔV1 is obtained by performing redundancy and security correction on the blow-out or complete deflation speed increment ratio ΔV₂, and ΔV1<ΔV₂.

In a class of this embodiment, Δt is dependent on to time from blow-out of the wheel occurs to complete deflation thereof, sinkage time of a vehicle, a vehicle type, and specification of the wheel and the rim, and is 500 ms±200 ms.

In a class of this embodiment, the wheel speed is obtained from an anti-lock brake system (ABS) wheel speed sensor, or other types of wheel speed sensors.

In a class of this embodiment, the wheel speed comprises an angular speed and/or a linear speed of the wheel.

In accordance with one embodiment of the invention, provided is a blow-out monitoring device, comprising a blow-out electronic controller unit, comprising an anti-lock brake system (ABS) electronic controller unit, an ABS electronic control program, a wheel speed signal processing circuit, a wheel speed signal processing program, a wheel speed signal operation circuit, a wheel speed signal operation program, a blow-out logic judging circuit, and a blow-out logic judging program, a braking executing unit comprising an electromagnetic valve, wherein the electromagnetic valve is disposed between a brake master cylinder and an ABS hydraulic controller, whereby disconnecting or connecting a hydraulic pipe between the brake master cylinder and the hydraulic controller via an electronic signal, as blow-out or complete deflation occurs, the blow-out electronic controller unit drives the electromagnetic valve disposed between the brake master cylinder and the ABS hydraulic controller to disconnect the hydraulic pipe between the brake master cylinder and the hydraulic controller, an ABS hydraulic pump operates and generates hydraulic brake force whereby facilitating braking and maintaining ABS functions, a blow-out or complete deflation speed increment ratio ΔV₂ is associated with a ratio of an normal impeller diameter Rₙₒᵣₘₐₗ to a complete deflation impeller diameter R_{deflation}, a threshold value comprises a blow-out or complete deflation speed increment ratio threshold ΔV1, and a blow-out or complete deflation speed increment variation rate threshold ΔV1/Δt, the blow-out electronic controller unit determines deflation occurs if a real-time speed increment ratio ΔV of one wheel is greater than or equal to the blow-out or complete deflation speed increment ratio threshold ΔV1, and the wheel speeds of other wheels are approximately constant, and the blow-out electronic controller unit determines blow-out occurs if the real-time speed increment ratio ΔV of one wheel is greater than or equal to the blow-out or complete deflation speed increment ratio threshold ΔV1, the wheel speeds of other wheels are approximately constant, and the real-time speed increment variation rate is greater than or equal to the blow-out or complete deflation speed increment variation rate threshold ΔV1/Δt.

In a class of this embodiment, the blow-out electronic controller unit executes braking and sends audible and visual alarm as blow-out or complete deflation occurs.

In a class of this embodiment, the electromagnetic valve is a two-position three-way or two-position two-way electromagnetic valve, and a valve core thereof has an anti-lock function.

In a class of this embodiment, the blow-out electronic controller unit powers on the electromagnetic valve and the hydraulic valve whereby disconnecting the hydraulic pipe between the brake master cylinder and the ABS hydraulic controller.

In a class of this embodiment, the blow-out electronic controller unit firstly powers on the electromagnetic valve and then on the hydraulic valve whereby disconnecting the hydraulic pipe between the brake master cylinder and the ABS hydraulic controller.

The invention is also applicable for updating and improvement of systems, such as electronic brakeforce distribution (EBD), electronic stability program and so on, derived from conventional ABS techniques.

Advantages of the invention comprise:

1. the invention is capable of monitoring and sampling blow-out signals generated by sudden variation of instant pressure, and controlling a vehicle after blow-out, and overcomes a problem with the conventional tire pressure monitoring system that instant blow-out signals during high-speed traveling cannot be monitored and sampled;

2. the invention associates the blow-out or complete deflation speed increment ratio ΔV2 with the normal impeller diameter ratio Rnormal and the complete deflation impeller diameter ratio Rdeflation, and the blow-out or complete deflation speed increment ratio ΔV2 is dependent on dimension of a wheel and a rim, and is independent on quality of the wheel, an environment, and a drive speed. The blow-out or complete deflation speed increment ratio ΔV2 has a large amplitude and is stable for monitoring and sampling, and thus making the invention suitable for monitoring tire pressure as a drive speed is above 100 km/h;

3. for vehicles with or without ABS, EBD and ESP functions, the wheel speed signal can be obtained via the ABS wheel speed sensor, a Hall sensor, a photoelectric sensor, and so on, which makes the invention simple in structure, reasonable, and low in cost.

### BRIEF DESCRIPTION OF THE DRAWINGS

FIG. 1 is a flow chart of a blow-out monitoring method of an exemplary embodiment of the invention; and

FIG. 2 is a block diagram of a blow-out monitoring device of another exemplary embodiment of the invention.

### DETAILED DESCRIPTION OF THE EMBODIMENTS

Detailed description will be given below in conjunction with accompanying drawings and specific embodiments.

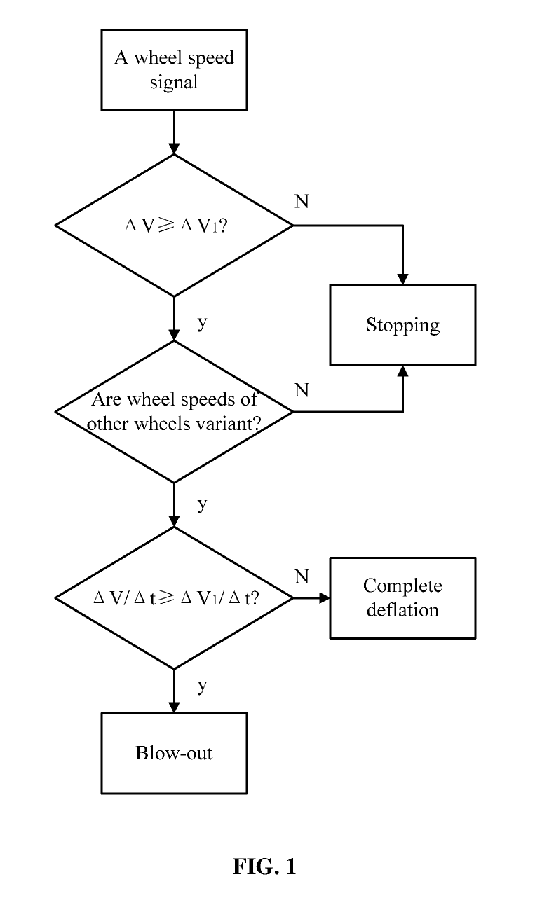

As shown in FIG. 1, a blow-out monitoring method of an embodiment of the invention comprises: Monitoring and sampling wheel speed signals continuously, or in a manner of pulse with a frequency greater than or equal to 10 Hz, obtaining wheel speed data comprising a real-time speed increment ratio ΔV of one wheel; and determining whether the real-time speed increment ratio ΔV is greater than or equal to a blow-out or complete deflation speed increment ratio threshold ΔV1 (ΔV1 is saved in an electronic controller unit according to a rim or a tire); if the real-time speed increment ratio ΔV is greater than or equal to the blow-out or complete deflation speed increment ratio threshold ΔV1, and wheel speeds of other wheels are approximately constant, it is determined that whether a real-time speed increment variation rate ΔV/Δt is greater than or equal to the blow-out or complete deflation speed increment variation rate threshold ΔV1/Δt, if ΔV/Δt is greater than or equal to ΔV1/Δt, then blow-out occurs, otherwise complete deflation caused by gas leakage occurs.

In this embodiment, the wheel speed data can be obtained via the ABS wheel speed sensor, or via other types of wheel speed sensors.

The blow-out or complete deflation speed increment ratio ΔV₂ is equal to (the normal impeller diameter Rₙₒᵣₘₐₗ/the complete deflation impeller diameter R_{deflation}−1)×100%.

For example, ωₙₒᵣₘₐₗ=V/(R_{deflation}+H), a size of a normal rim is 13-19 inches, a radius thereof R is 165 mm-241 mm, a flatness ratio thereof is 45-90, a height of a tire H=flatness ratio×a width of the tire, for a 195/60R14 tire, a height thereof H=0.65×195=117 mm, for a 215/45R17 tire, a height thereof H=0.45×215=96.75 mm For a normal tire with a flatness ratio of 60, a remaining height thereof after blow-out is 30 mm, and a variation in height (effective rolling radius) after blow-out is 60 mm-100 mm, a ratio between a wheel speed after blow-out and that before blow-out is 1.2-1.4, namely the blow-out or complete deflation speed increment ratio ΔV₂=20%-40%.

The blow-out or complete deflation speed increment ratio threshold ΔV1 is obtained by performing redundancy and security correction on the blow-out or complete deflation speed increment ratio ΔV₂, and ΔV1 is 0.7-0.8 times than ΔV₂.

As ΔV is greater than or equal to ΔV1, and speeds of other wheels are approximately constant, then it is determined that complete deflation occurs.

As a real-time speed increment variation rate ΔV/Δt is greater than or equal to the blow-out or complete deflation speed increment variation rate threshold ΔV1/Δt, it is determined that blow-out occurs.

Experiments indicate that time from blow-out occurs to complete deflation is approximately 100 ms, time from complete deflation to sinkage of the vehicle (as the rim rolls on the tire) is 200 ms-500 ms (there is difference between the front and the rear wheel), and Δt is equal to 500 ms±200 ms.

The speed increment variation rate can be obtained via fixed-time frequency measuring method, fixed-frequency time measuring method, or continuous sampling method, and so on.

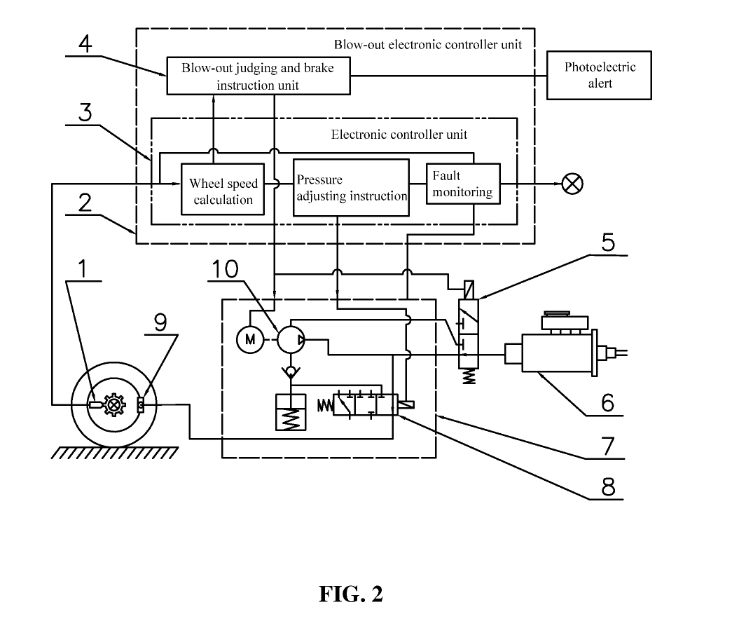

As shown in FIG. 2, a blow-out monitoring device comprises a blow-out electronic controller unit, comprising an anti-lock brake system (ABS) electronic controller unit, an ABS electronic control program, a wheel speed signal processing circuit, a wheel speed signal processing program, a wheel speed signal operation circuit, a wheel speed signal operation program, a blow-out logic judging circuit, and a blow-out logic judging program; and a braking executing unit comprising an electromagnetic valve.

The braking executing unit is improvement of a conventional ABS hydraulic braking pipe (a hydraulic pipe and electric control), a two-position three-way electromagnetic valve 5 is serially connected between a brake master cylinder 6 and a hydraulic controller 7, and the two-position three-way electromagnetic valve 5 is always on. In a normal state (power off), a braking pipe between the brake master cylinder 6 and a three-position three-way electromagnetic valve 8 is kept on.

An electric hydraulic pump 10, a braking pump 9, the three-position three-way electromagnetic valve 8, a wheel speed sensor 1, and the electronic controller unit 3 are main parts of an ABS system of a vehicle. Blow-out judging and brake instruction unit 4 is upgrade of the electronic controller unit 3. The blow-out electronic controller unit 2 comprises the electronic controller unit 3 and the blow-out judging and brake instruction unit 4.

As the blow-out electronic controller unit 2 detects a blow-out signal, the blow-out electronic controller unit 2 simultaneously powers on the two-position three-way electromagnetic valve 5 and the electric hydraulic pump 10, the two-position three-way electromagnetic valve 5 is inverted, and disconnects the hydraulic pipe between the brake master cylinder 6 and the electric hydraulic pump 10. At this time the electric hydraulic pump 10 operates and generates pressure in the braking pipe, and thus the vehicle is braked.

As pressure in the braking pipe is too high and the wheel is lock up and slides, an ABS control program joins the braking process, and an ABS function of a vehicle starts operating.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A method for tire monitoring, comprising:
determining that complete deflation or blow-out occurs if speed variation of one wheel of a vehicle is larger than or equal to a threshold value, and wheel speeds of other wheels of said vehicle are approximately constant, said threshold value comprising a blow-out or complete deflation speed increment ratio threshold ΔV1, and a blow-out or complete deflation speed increment variation rate threshold ΔV1/Δt;
associating a blow-out or complete deflation speed increment ratio ΔV₂ with a ratio of an normal impeller diameter Rₙₒᵣₘₐₗ to a complete deflation impeller diameter R_{deflation};
detecting whether a real-time speed increment ratio ΔV of one wheel is greater than or equal to said blow-out or complete deflation speed increment ratio threshold ΔV1, wheel speeds of other wheels are approximately constant, and a real-time speed increment variation rate is greater than or equal to said blow-out or complete deflation speed increment variation rate threshold ΔV1/Δt;
determining that deflation occurs if said real-time speed increment ratio ΔV of one wheel is greater than or equal to said blow-out or complete deflation speed increment ratio threshold ΔV1, and said wheel speeds of other wheels are approximately constant; and
determining that blow-out occurs if said real-time speed increment ratio ΔV of one wheel is greater than or equal to said blow-out or complete deflation speed increment ratio threshold ΔV1, said wheel speeds of other wheels are approximately constant, and said real-time speed increment variation rate is greater than or equal to said blow-out or complete deflation speed increment variation rate threshold ΔV1/Δt.

2. The method of claim 1, wherein said blow-out or complete deflation speed increment ratio ΔV₂ is equal to (said normal impeller diameter Rₙₒᵣₘₐₗ/said complete deflation impeller diameter R_{deflation}−1)×100%.

3. The method of claim 2, wherein said blow-out or complete deflation speed increment ratio ΔV₂ is dependent on dimension of a wheel and a rim, and is independent on quality of said wheel, an environment, and a drive speed.

4. The method of claim 1, wherein said blow-out or complete deflation speed increment ratio threshold ΔV1 is obtained by performing redundancy and security correction on said blow-out or complete deflation speed increment ratio ΔV₂, and ΔV1<ΔV₂.

5. The method of claim 1, wherein Δt is dependent on to time from blow-out of said wheel occurs to complete deflation thereof, sinkage time of a vehicle, a vehicle type, and specification of said wheel and said rim, and is 500 ms±200 ms.

6. The method of claim 1, wherein said wheel speed is obtained from an anti-lock brake system (ABS) wheel speed sensor, or other types of wheel speed sensors.

7. The method of claim 1, wherein said wheel speed comprises an angular speed and/or a linear speed of said wheel.

8. A tire blow-out monitoring device, comprising
a blow-out electronic controller unit, comprising an anti-lock brake system (ABS) electronic controller unit, an ABS electronic control program, a wheel speed signal processing circuit, a wheel speed signal processing program, a wheel speed signal operation circuit, a wheel speed signal operation program, a blow-out logic judging circuit, and a blow-out logic judging program;
a braking executing unit comprising an electromagnetic valve;
wherein
said electromagnetic valve is disposed between a brake master cylinder and an ABS hydraulic controller, whereby disconnecting or connecting a hydraulic pipe between said brake master cylinder and said hydraulic controller via an electronic signal;
as blow-out or complete deflation occurs, said blow-out electronic controller unit drives said electromagnetic valve disposed between said brake master cylinder and said ABS hydraulic controller to disconnect said hydraulic pipe between said brake master cylinder and said hydraulic controller, an ABS hydraulic pump operates and generates hydraulic brake force whereby facilitating braking and maintaining ABS functions;
a blow-out or complete deflation speed increment ratio ΔV₂ is associated with a ratio of an normal impeller diameter Rₙₒᵣₘₐₗ to a complete deflation impeller diameter R_{deflation};
a threshold value comprises a blow-out or complete deflation speed increment ratio threshold ΔV1, and a blow-out or complete deflation speed increment variation rate threshold ΔV1/Δt;
said blow-out electronic controller unit determines deflation occurs if a real-time speed increment ratio ΔV of one wheel is greater than or equal to said blow-out or complete deflation speed increment ratio threshold ΔV1, and said wheel speeds of other wheels are approximately constant; and
said blow-out electronic controller unit determines blow-out occurs if said real-time speed increment ratio ΔV of one wheel is greater than or equal to said blow-out or complete deflation speed increment ratio threshold ΔV1, said wheel speeds of other wheels are approximately constant, and said real-time speed increment variation rate is greater than or equal to said blow-out or complete deflation speed increment variation rate threshold ΔV1/Δt.

9. The device of claim 8, wherein said blow-out electronic controller unit executes braking and sends audible and visual alarm as blow-out or complete deflation occurs.

10. The device of claim 8, wherein said electromagnetic valve is a two-position three-way or two-position two-way electromagnetic valve, and a valve core thereof has an anti-lock function.

11. The device of claim 8, wherein said blow-out electronic controller unit powers on said electromagnetic valve and said hydraulic valve whereby disconnecting said hydraulic pipe between said brake master cylinder and said ABS hydraulic controller.

12. The device of claim 8, wherein said blow-out electronic controller unit firstly powers on said electromagnetic valve and then on said hydraulic valve whereby disconnecting said hydraulic pipe between said brake master cylinder and said ABS hydraulic controller.
